(19) United States
(12) Patent Application Publication
(10) Pub. No.: US 2018/0231256 A1
(43) Pub. Date: Aug. 16, 2018

(54) Rotating Detonation Combustor

(71) Applicant: General Electric Company, Schenectady, NY (US)

(72) Inventors: Sibtosh Pal, Mason, OH (US); Joseph Zelina, Waynesville, OH (US); Arthur Johnson, Cincinnati, OH (US); Clayton S. Cooper, Loveland, OH (US); Steven Vise, Loveland, OH (US)

(21) Appl. No.: 15/429,655

(22) Filed: Feb. 10, 2017

(51) Int. Cl. F23R 7/00; F02C 5/02

(52) U.S. Cl. CPC F23R 7/00; F02K 3/06; F02C 5/02

(57) ABSTRACT

A rotating detonation combustion system includes an outer wall and an inner wall together defining at least in part a combustion chamber and a combustion chamber inlet. A nozzle of the rotating detonation combustion system is located at the combustion chamber inlet, the nozzle defining a lengthwise direction and extending between a nozzle inlet and a nozzle outlet along the lengthwise direction. The nozzle further defines a throat between the nozzle inlet and nozzle outlet. A fuel injection port is also provided, the fuel injection port defining a fuel outlet located between the nozzle inlet and the nozzle outlet for providing fuel to a flow of oxidizer received through the nozzle inlet.

### FIELD

The present subject matter relates generally to a system and method of continuous detonation in an engine.

### BACKGROUND

Typical gas turbine engines are based on the Brayton Cycle, where air is compressed adiabatically, heat is added at constant pressure, the resulting hot gas is expanded in a turbine, and heat is rejected at constant pressure. The energy above that required to drive the compression system is then available for propulsion or other work. Such gas turbine engines generally rely upon deflagrative combustion to burn a fuel/air mixture and produce combustion gas products which travel at relatively slow rates and constant pressure within a combustion chamber. While engines based on the Brayton Cycle have reached a high level of thermodynamic efficiency by steady improvements in component efficiencies and increases in pressure ratio and peak temperature, further improvements are welcomed nonetheless.

Accordingly, improvements in engine efficiency have been sought by modifying the engine architecture such that the combustion occurs as a detonation in either a continuous or pulsed mode. Most pulse detonation devices employ detonation tubes that are fed with a fuel/air mixture that is subsequently ignited. A combustion pressure wave is then produced, which transitions into a detonation wave (i.e., a fast moving shock wave closely coupled to the reaction zone). The products of combustion follow the detonation wave at the speed of sound relative to the detonation wave and at significantly elevated pressure. Such combustion products may then exit through a nozzle to produce thrust or rotate a turbine.

Simple pulse detonation engines have no moving parts with the exception of various forms of externally actuated valves. Such valves are used to control the duration of the fuel/air introduction and to prevent backflow of combustion products during the detonation process. While such pulse detonation configurations have advanced the state of the art, the valves and associated actuators are subjected to very high temperatures and pressures. This not only presents a reliability problem, but can also have a detrimental effect on the turbomachinery of the engine.

With other pulse detonation systems, the task of preventing backflow into the lower pressure regions upstream of the pulse detonation has been addressed by providing a steep pressure drop into the combustion chamber. However, such may reduce the efficiency benefits of the rotating detonation combustion system. Accordingly, a rotating detonation combustion system capable of addressing these concerns without providing for a steep pressure drop into the combustion chamber would be useful.

### BRIEF DESCRIPTION

Aspects and advantages of the invention will be set forth in part in the following description, or may be obvious from the description, or may be learned through practice of the invention.

In one exemplary embodiment of the present disclosure, a rotating detonation combustion system defining a radial direction and a circumferential direction is provided. The rotating detonation combustion system including an outer wall and an inner wall together defining at least in part a combustion chamber and a combustion chamber inlet. The rotating detonation combustion system also includes a nozzle located at the combustion chamber inlet defined by the outer wall and the inner wall. The nozzle defines a lengthwise direction and extends between a nozzle inlet and a nozzle outlet along the lengthwise direction. The nozzle inlet is configured to receive a flow of oxidizer. The nozzle further defines a throat between the nozzle inlet and nozzle outlet. The rotating detonation combustion system also includes a fuel injection port defining a fuel outlet located between the nozzle inlet and the nozzle outlet for providing fuel to the flow of oxidizer received through the nozzle inlet.

In certain exemplary embodiments, the nozzle is configured as one of a plurality of nozzles arranged in an array along the circumferential direction. For example, in certain exemplary embodiments the plurality of nozzles may include a first array of nozzles and a second array of nozzles, wherein the second array of nozzles is located outward of the first array of nozzles along the radial direction. Furthermore, for example, in exemplary embodiments may further include the plurality of nozzles further includes a third array of nozzles, wherein the third array of nozzles is located outward of the second array of nozzles along the radial direction. Additionally, or alternatively, in certain embodiments the plurality of nozzles includes at least fifty nozzles spaced along the circumferential direction.

In certain exemplary embodiments the nozzle inlet defines a nozzle inlet cross-sectional area, the throat defines a throat cross-sectional area, and the throat cross-sectional area is less than or equal to about one half of the nozzle inlet cross-sectional area. For example, in certain exemplary embodiments the nozzle outlet defines a nozzle outlet cross-sectional area, with the nozzle outlet cross-sectional area being less than or equal to the nozzle inlet cross-sectional area.

In certain exemplary embodiments the nozzle defines a length along the lengthwise direction, and the throat is positioned in a forward half of the length of the nozzle.

In certain exemplary embodiments the fuel outlet of the fuel injection port is positioned at the throat of the nozzle or positioned downstream of the throat of the nozzle along the lengthwise direction of the nozzle.

In certain exemplary embodiments the nozzle defines a nozzle length, wherein the fuel outlet of the fuel injection port is positioned at the throat of the nozzle or within a buffer distance from the throat of the nozzle along the lengthwise direction. In such an embodiment, the buffer distance may be ten percent of the nozzle length.

In certain exemplary embodiments the fuel injection port is integrated into the nozzle.

In certain exemplary embodiments the rotating detonation combustion system further defines a longitudinal centerline, and wherein the lengthwise direction of the nozzle is substantially parallel to the longitudinal centerline.

In certain exemplary embodiments the rotating detonation combustion system further defines a longitudinal centerline, wherein the longitudinal centerline and the radial direction together define a reference plane, wherein the lengthwise direction of the nozzle intersects the reference plane and defines an angle greater than zero degrees and less than forty-five degrees with the reference plane.

In certain exemplary embodiments the fuel injection port comprises a plurality of fuel injection ports.

In another exemplary embodiment of the present disclosure, a turbine engine is provided. The turbine engine includes a turbine section and a rotating detonation combustion system located upstream of the turbine section. The rotating detonation combustion system includes an outer wall and an inner wall together defining in part a combustion chamber, a combustion chamber inlet, and a combustion chamber outlet. The combustion chamber outlet is in flow communication with the turbine section. The rotating detonation combustion system also includes a nozzle located at the combustion chamber inlet defined by the outer wall and the inner wall. The nozzle defines a lengthwise direction and extends between a nozzle inlet and a nozzle outlet along the lengthwise direction. The nozzle inlet is configured to receive a flow of oxidizer. The nozzle further defines a throat between the nozzle inlet and nozzle outlet. The rotating detonation combustion system also includes a fuel injection port defining a fuel outlet located between the nozzle inlet and the nozzle outlet for providing fuel to the flow of oxidizer received through the nozzle inlet.

In an exemplary aspect of the present disclosure, a method of operating a rotating detonation combustion system is provided. The rotating detonation combustion system defines a combustion chamber and includes a nozzle located at an inlet to the combustion chamber. The method includes providing a flow of oxidizer to a nozzle inlet of the nozzle, compressing the flow of oxidizer provided to the nozzle inlet through a converging section of the nozzle, and providing the flow of oxidizer compressed through the converging section of the nozzle to a throat of the nozzle. The method also includes expanding the flow of oxidizer from the throat through a diverging section of the nozzle, and injecting a fuel into at least one of the converging section, the throat, or the diverging section to generate an oxidizer/fuel mixture. The method also includes igniting the oxidizer/fuel mixture within the combustion chamber to generate at least one detonation wave within the combustion chamber.

In certain exemplary aspects the flow of oxidizer through the throat of the nozzle defines a speed within about a twenty percent margin of Mach 1.

In certain exemplary aspects injecting a fuel into at least one of the converging section, the throat, or the diverging section includes injecting fuel through an outlet of a fuel injection port.

In certain exemplary aspects the method also includes providing the oxidizer/fuel mixture from the nozzle to the combustion chamber with a pressure drop across the nozzle of less than about twenty-five percent.

In certain exemplary aspects the method also includes providing the oxidizer/fuel mixture from the nozzle to the combustion chamber with a pressure drop across the nozzle of less than about fifteen percent.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic view of a gas turbine engine in accordance with an exemplary embodiment of the present disclosure.

FIG. 2 is a side, cross-sectional view of a rotating detonation combustion system in accordance with an exemplary embodiment of the present disclosure.

FIG. 3 is a perspective view of a combustion chamber of the exemplary rotating detonation combustion system of FIG. 2.

FIG. 4 is a close-up, side, cross-sectional view of a nozzle of the exemplary rotating detonation combustion system of FIG. 2 in accordance with an exemplary embodiment of the present disclosure.

FIG. 5 is an axial view of the exemplary rotating detonation combustion system of FIG. 2.

FIG. 6 is a radially outer, partially cross-sectional view of a forward end of the exemplary rotating detonation combustion system of FIG. 2.

FIG. 7 is a radially outer, partially cross-sectional view of a forward end of a rotating detonation combustion system in accordance with another exemplary embodiment of the present disclosure.

FIG. 8 is a flow diagram of a method for operating a rotating detonation combustion system in accordance with an exemplary aspect of the present disclosure.

### DETAILED DESCRIPTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

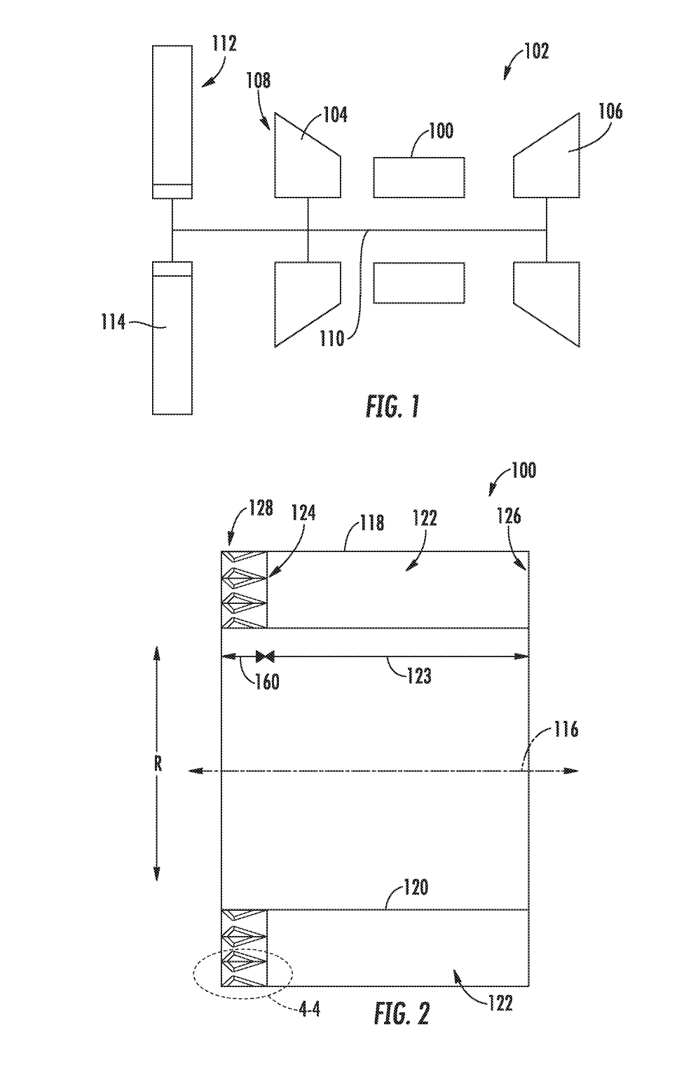

Referring now figures, FIG. 1 depicts an engine including a rotating detonation combustion system 100 (an “RDC system”) in accordance with an exemplary embodiment of the present disclosure. For the embodiment of FIG. 1, the engine is generally configured as a turbofan engine 102. More specifically, the turbofan engine 102 generally includes a compressor section 104 and a turbine section 106, with the RDC system 100 located downstream of the compressor section 104 and upstream of the turbine section 106. During operation, an airflow may be provided to an inlet 108 of the compressor section 104, wherein such airflow is compressed through one or more compressors, each of which may include one or more alternating stages of compressor rotor blades and compressor stator vanes. As will be discussed in greater detail below, compressed air from the compressor section 104 may then be provided to the RDC system 100, wherein the compressed air may be mixed with a fuel and detonated to generate combustion products. The combustion products may then flow to the turbine section 106 wherein one or more turbines may extract kinetic/rotational energy from the combustion products. As with the compressor(s) within the compressor section 104, each of the turbine(s) within the turbine section 106 may include one or more alternating stages of turbine rotor blades and turbine stator vanes. The combustion products may then flow from the turbine section 106 through, e.g., an exhaust nozzle 140 (not shown) to generate thrust for the turbofan engine 102.

As will be appreciated, rotation of the turbine(s) within the turbine section 106, generated by the combustion products, is transferred through one or more shafts or spools 110 to drive the compressor(s) within the compressor section 104. Additionally, for the embodiment depicted, the turbofan engine 102 includes a fan section 112 at a forward end. The fan section 112 includes a fan 114 that is also driven by/rotatable by the turbine section 106. More specifically, for the embodiment depicted, the one or more shafts or spools 110 mechanically connects to the fan 114 of the fan section 112 for driving the fan 114 of the fan section 112.

It will be appreciated that the turbofan engine 102 depicted schematically in FIG. 1 is provided by way of example only. In certain exemplary embodiments, the turbofan engine 102 may include any suitable number of compressors within the compressor section 104, any suitable number of turbines within the turbine section 106, and further may include any number of shafts or spools 110 appropriate for mechanically linking the compressor(s), turbine(s), and/or fans (such as fan 114). Similarly, in other exemplary embodiments, the turbofan engine 102 may include any suitable fan section 112, with a fan 114 thereof being driven by the turbine section 106 in any suitable manner. For example, in certain embodiments, the fan 114 may be directly linked to a turbine within the turbine section 106, or alternatively, may be driven by a turbine within the turbine section 106 across a reduction gearbox. Additionally, the fan 114 may be a variable pitch fan, a fixed pitch fan, a ducted fan (i.e., the turbofan engine 102 may include an outer nacelle surrounding the fan section 112), an un-ducted fan, or may have any other suitable configuration.

Moreover, it should also be appreciated that the RDC system 100 may further be incorporated into any other suitable aeronautical gas turbine engine, such as a turboshaft engine, a turboprop engine, a turbojet engine, a ramjet engine, a scramjet engine, etc. Further, in certain embodiments, the RDC system 100 may be incorporated into a non-aeronautical gas turbine engine, such as a land-based power-generating gas turbine engine, an aero-derivative gas turbine engine, etc. Further, still, in certain embodiments, the RDC system 100 may be incorporated into any other suitable engine, such as a rocket or missile engine. With one or more of the latter embodiments, the engine may not include a compressor section 104 or a turbine section 106, and instead may simply include a nozzle 140 with the combustion products flowing therethrough to generate thrust.

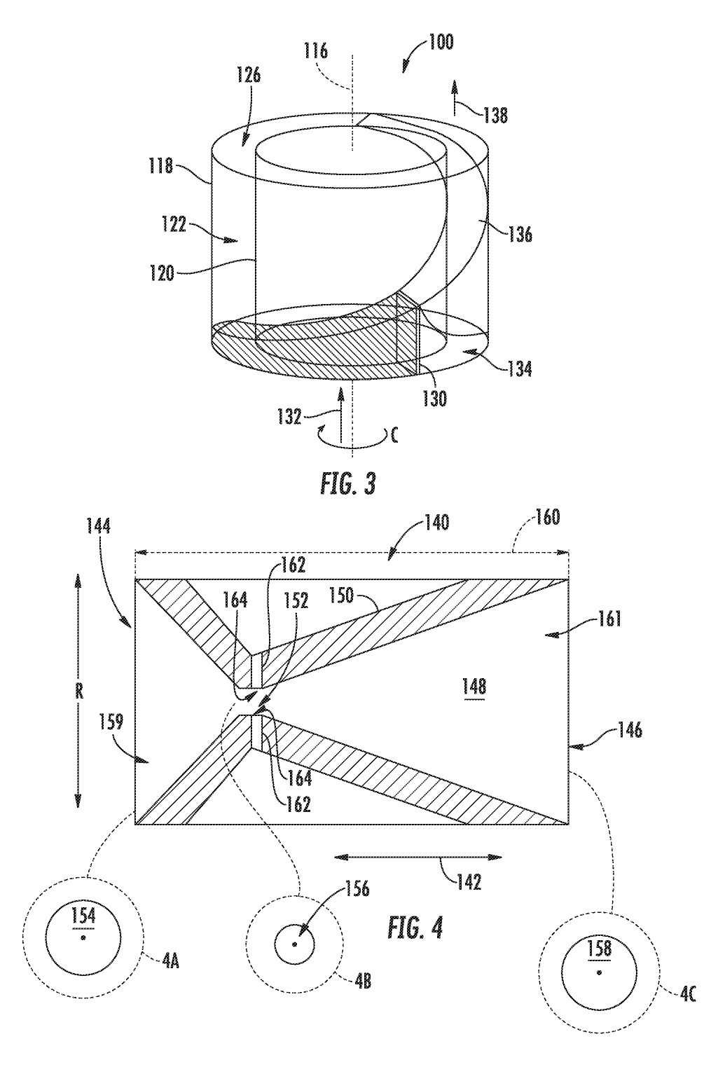

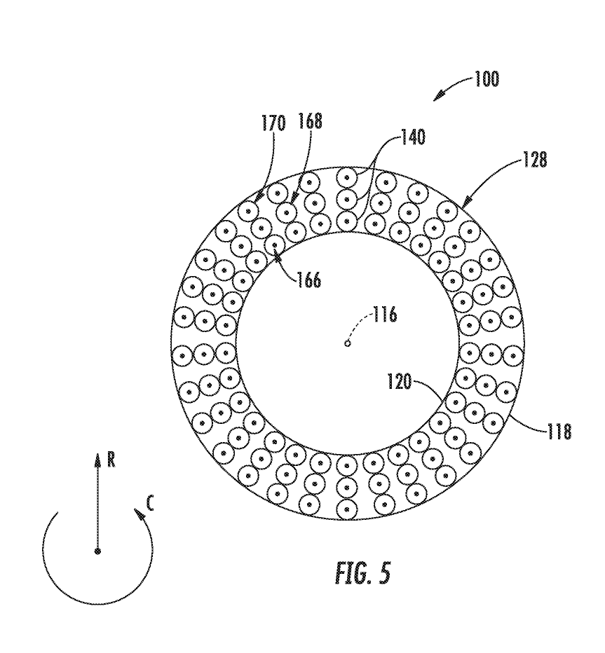

Referring now to FIG. 2, a side, schematic view is provided of an exemplary RDC system 100 as may be incorporated into the exemplary embodiment of FIG. 1. As shown, the RDC system 100 generally defines a longitudinal centerline 116, a radial direction R relative to the longitudinal centerline 116, and a circumferential direction C relative to the longitudinal centerline 116 (see, e.g., FIGS. 3 and 5).

The RDC system 100 generally includes an outer wall 118 and an inner wall 120 spaced from one another along the radial direction R. The outer wall 118 and the inner wall 120 together define in part a combustion chamber 122, a combustion chamber inlet 124, and a combustion chamber outlet 126. The combustion chamber 122 defines a combustion chamber length 123 along the longitudinal centerline 116. Although the combustion chamber 122 is depicted as a single combustion chamber, in other exemplary embodiments of the present disclosure, the RDC system 100 (through the inner and outer walls 120, 118 and/or other walls not depicted) may include multiple combustion chambers.

Further, the RDC system 100 includes a nozzle assembly 128 located at the combustion chamber inlet 124. The nozzle assembly 128 provides a flow mixture of oxidizer and fuel to the combustion chamber 122, wherein such mixture is combusted/detonated to generate the combustion products therein, and more specifically a detonation wave 130 as will be explained in greater detail below. The combustion products exit through the combustion chamber outlet 126.

Referring briefly to FIG. 3, providing a perspective view of the combustion chamber 122 (without the nozzle assembly 128), it will be appreciated that the RDC system 100 generates the detonation wave 130 during operation. The detonation wave 130 travels in the circumferential direction C of the RDC system 100 consuming an incoming fuel/oxidizer mixture 132 and providing a high pressure region 134 within an expansion region 136 of the combustion. A burned fuel/oxidizer mixture 138 (i.e., combustion products) exits the combustion chamber 122 and is exhausted with the exhaust flow.

More particularly, it will be appreciated that the RDC system 100 is of a detonation-type combustor, deriving energy from the continuous wave 130 of detonation. For a detonation combustor, such as the RDC system 100 disclosed herein, the combustion of the fuel/oxidizer mixture 132 is effectively an explosion as compared to a burning, as is typical in the traditional deflagration-type combustors. Accordingly, a main difference between deflagration and detonation is linked to the mechanism of flame propagation. In deflagration, the flame propagation is a function of the heat transfer from a reactive zone to the fresh mixture, generally through conduction. By contrast, with a detonation combustor, the detonation is a shock induced flame, which results in the coupling of a reaction zone and a shockwave. The shockwave compresses and heats the fresh mixture 132, increasing such mixture 132 above a self-ignition point. On the other side, energy released by the combustion contributes to the propagation of the detonation shockwave 130. Further, with continuous detonation, the detonation wave 130 propagates around the combustion chamber 122 in a continuous manner, operating at a relatively high frequency. Additionally, the detonation wave 130 may be such that an average pressure inside the combustion chamber 122 is higher than an average pressure within typical combustion systems (i.e., deflagration combustion systems).

Accordingly, the region 134 behind the detonation wave 130 has very high pressures. As will be appreciated from the discussion below, the nozzle assembly 128 of the RDC system 100 is designed to prevent the high pressures within the region 134 behind the detonation wave 130 from flowing in an upstream direction, i.e., into the incoming flow of the fuel/oxidizer mixture 132.

Referring back to FIG. 2, and now also to FIG. 4, the nozzle assembly 128 includes a plurality of nozzles 140. Referring particularly to the close up, side, cross-sectional view of the nozzle 140 depicted in FIG. 4 (identified by Circle 4-4 in FIG. 2), the nozzle 140 is located at the combustion chamber inlet 124 and defines a lengthwise direction 142. In certain exemplary embodiments, the lengthwise direction 142 may extend parallel to the longitudinal centerline 116 of the combustor 100. Alternatively, however, in other embodiments, the combustor 100 may be configured such that the lengthwise direction 142 of the nozzles 140 defines an angle with the longitudinal centerline, such as an angle between two degrees and forty-five degrees, such as between five degrees and thirty degrees.

Referring still to FIGS. 2 and 4, the nozzle 140 extends along the lengthwise direction 142 between a nozzle inlet 144 and a nozzle outlet 146, and further defines a nozzle flowpath 148 extending from the nozzle inlet 144 to the nozzle outlet 146. More specifically, for the embodiment depicted, the nozzle 140 includes a nozzle wall 150 defining the nozzle flowpath 148. For the embodiment depicted, the nozzle wall 150 is a continuous nozzle wall extending from the nozzle inlet 144 to the nozzle outlet 146. However, in other embodiments, the nozzle wall 150 may have any other suitable configuration.

The nozzle inlet 144 is configured to receive a flow of oxidizer during operation of the RDC system 100 and provide such flow oxidizer through/along the nozzle flowpath 148. The flow of oxidizer may be a flow of air, oxygen, etc. More specifically, when the nozzle 140 of the nozzle assembly 128 is incorporated into the RDC system 100 of the turbofan engine 102 of FIG. 1, the flow oxidizer will be a flow of compressed air from the compressor section 104.

The nozzle 140, or rather the nozzle wall 150, further defines a throat 152 between the nozzle inlet 144 and the nozzle outlet 146, i.e., downstream of the nozzle inlet 144 and upstream of the nozzle outlet 146. As used herein, the term “throat”, with respect to the nozzle 140, refers to the point within the nozzle flowpath 148 having the smallest cross-sectional area. Additionally, as used herein, the term “cross-sectional area”, such as a cross-sectional area 156 of the throat 152 (described in more detail below), refers to an area within the nozzle flowpath 148 at a cross-section measured along the radial direction R at the respective location along the nozzle flowpath 148.

Accordingly, it will be appreciated that for the embodiment depicted the nozzle inlet 144 defines a nozzle inlet cross-sectional area 154 and the throat 152 defines the throat cross-sectional area 156 (see callout circles 4A and 4B in FIG. 4, depicting the nozzle inlet cross-sectional area 154 and throat cross-sectional area 156, respectively, along the lengthwise direction 142). For the embodiment depicted, the throat cross-sectional area 156 is less than or equal to about one half of the nozzle inlet cross-sectional area 154. For example, in certain exemplary embodiments, the throat cross-sectional area 156 may be between about five percent and about fifty percent of the nozzle inlet cross-sectional area 154, such as between about ten percent and about forty percent of the nozzle inlet cross-sectional area 154, such as between about fifteen percent and about thirty-five percent of the nozzle inlet cross-sectional area 154.

Similarly, for the embodiment depicted, the nozzle outlet 146 defines a nozzle outlet cross-sectional area 158 (see callout circle 4C in FIG. 4, depicting the nozzle outlet cross-sectional area 158 along the lengthwise direction 142). The nozzle outlet cross-sectional area 158 is less than or equal to the nozzle inlet cross-sectional area 154. For example, in certain exemplary embodiments, the nozzle outlet cross-sectional area 158 may be between about seventy-five percent and one hundred percent of the nozzle inlet cross-sectional area 154, such as between about eighty percent and about ninety-five percent of the nozzle inlet cross-sectional area 154.

Notably, however, in other embodiments, the nozzle outlet cross-sectional area 158 may instead be greater than the nozzle inlet cross-sectional area 154. For example, in other exemplary embodiments, the nozzle outlet cross-sectional area 158 may be between about one hundred percent and two hundred percent of the nozzle inlet cross-sectional area 154.

Given the above description, it will be appreciated that the nozzle 140 may be referred to as a converging-diverging nozzle. Further, for the embodiment depicted, the throat 152 is positioned closer to the nozzle inlet 144 than the nozzle outlet 146 along the lengthwise direction 142 of the nozzle 140. More specifically, as is depicted, the nozzle 140 defines a length 160 along the lengthwise direction 142. The throat 152 for the exemplary nozzle 140 depicted is positioned in a forward, or upstream, half of the length 160 of the nozzle 140. More specifically, still, for the embodiment depicted the throat 152 of the exemplary nozzle 140 depicted is positioned approximately between the forward ten percent and fifty percent of the length 160 of the nozzle 140 along the lengthwise direction 142, such as approximately between the forward twenty percent and forty percent of the length 160 of the nozzle 140 along the lengthwise direction 142.

A nozzle 140 having such a configuration may provide for a substantially subsonic flow through the nozzle flowpath 148. For example, the flow from the nozzle inlet 144 to the throat 152 (i.e., a converging section 159 of the nozzle 140) may define an airflow speed below Mach 1. The flow through the throat 152 may define an airflow speed less than Mach 1, but approaching Mach 1, such as within about ten percent of Mach 1, such as within about five percent of Mach 1. Additionally, the flow from the throat 152 to the nozzle outlet 146 (i.e., a diverging section 161 of the nozzle 140) may again define an airflow speed below Mach 1 and less than the airflow speed through the throat 152.

As is also depicted, the RDC system 100 further includes a fuel injection port 162. The fuel injection port 162 defines a fuel outlet 164 in fluid communication with the nozzle flowpath 148 and located between the nozzle inlet 144 and the nozzle outlet 146 for providing fuel to the flow of oxidizer received through the nozzle inlet 144. More specifically, for the embodiment depicted, the fuel outlet 164 of the fuel injection port 162 is positioned within a buffer distance from the throat 152 of the nozzle 140 along the lengthwise direction 142 of the nozzle 140 (with the buffer distance being a distance equal to ten percent of the length 160 of the nozzle 140 along the lengthwise direction 142). More particularly, for the embodiment depicted, the fuel outlet 164 of the fuel injection port 162 is positioned at the throat 152 of the nozzle 140, or downstream of the throat 152 of the nozzle 140 along the lengthwise direction 142 of the nozzle 140. More specifically still, for the embodiment depicted, the fuel outlet 164 of the fuel injection port 162 is positioned at the throat 152 of the nozzle 140. It will be appreciated, that as used herein, the term “at the throat of the nozzle” refers to including at least a portion of the component or feature positioned at a location within the nozzle flowpath 148 defining the smallest cross-sectional area (i.e., defining the throat 152). Notably, for the embodiment of FIG. 4, the throat 152 of the exemplary nozzle 140 depicted is not a single point along the lengthwise direction 142, and instead extends for a distance along the lengthwise direction 142. For the purposes of measuring locations of features or parts relative to the throat 152, the measurement may be taken from anywhere within the nozzle flowpath 148 defining the throat 152. Notably, although the fuel injection port 162 is depicted as including two outlets 164, in other embodiments, the fuel injection port 162 may have any other suitable number of outlets 164, and further the RDC system 100 may include any suitable number of fuel injection ports 162. The outlets 164 and/or fuel injection ports 162 (when multiple are provided) may be oriented in any suitable pattern.

The fuel provided through the fuel injection port 162 may be any suitable fuel, such as a hydrocarbon-based fuel, for mixing with the flow of oxidizer. More specifically, for the embodiment depicted the fuel injection port 162 is a liquid fuel injection port configured to provide a liquid fuel to the nozzle flowpath 148, such as a liquid jet fuel. However, in other exemplary embodiments, the fuel may be a gas fuel or any other suitable fuel.

Accordingly, for the embodiment depicted, positioning the fuel outlet 164 of the fuel injection port 162 in accordance with the description above may allow for the liquid fuel provided through the outlet 164 of the fuel injection port 162 to substantially completely atomize within the flow of oxidizer provided through the nozzle inlet 144 of the nozzle 140. Such may provide for a more complete mixing of the fuel within the flow of oxidizer, providing for a more complete and stable combustion within the combustion chamber 122.

Furthermore, for the embodiment depicted, the fuel injection port 162 is integrated into the nozzle 140. More specifically, for the embodiment depicted, the fuel injection port 162 extends through, and may be at least partially defined by, or positioned within, an opening extending through the nozzle wall 150 of the nozzle 140. Additionally, for the embodiment, the fuel injection port 162 further includes a plurality of fuel injection ports 162, with each fuel injection port 162 defining an outlet 164.

It should be appreciated, however, that in other exemplary embodiments, the fuel injection port 162 may instead be a single fuel injection port, or further may include any other suitable number and/or pattern of fuel injection ports 162. Each of the one or more fuel injection ports 162 may be fluidly connected to a fuel source, such as a fuel tank, through one or more fuel lines for supplying the fuel to the fuel injection ports 162 (not shown). Additionally, it should be appreciated, that in other exemplary embodiments, the fuel injection port 162 may not be integrated into the nozzle 140. With such an exemplary embodiment, the RDC system 100 may instead include a fuel injection port having a separate structure extending, e.g., through the nozzle inlet 144 and nozzle flowpath 148. Such a fuel injection port may further define a fuel outlet positioned in the nozzle flowpath 148 between the nozzle inlet 144 and the nozzle outlet 146 for providing fuel to the flow of oxidizer received through the nozzle inlet 144.

A nozzle 140 in accordance with one or more of the exemplary embodiments described herein may allow for a relatively low pressure drop from the nozzle inlet 144 to the nozzle outlet 146 and into the combustion chamber 122. For example, in certain exemplary embodiments, a nozzle 140 in accordance with one or more of the exemplary embodiments described herein may provide for a pressure drop of less than about twenty percent. For example, in certain exemplary embodiments the nozzle 140 may provide for a pressure drop less than about twenty-five percent, such as between about one percent and about fifteen percent, such as between about one percent and about ten percent, such as between about one percent and about eight percent, such as between about one percent and about six percent. It should be appreciated, that as used herein, the term “pressure drop” refers to a pressure difference between a flow at the nozzle outlet 146 and at the nozzle inlet 144, as a percentage of the pressure of the flow at the nozzle inlet 144. Notably, including a nozzle 140 having such a relatively low pressure drop may generally provide for a more efficient RDC system 100. In addition, inclusion of a nozzle 140 having a converging-diverging configuration as is depicted and/or described herein may prevent or greatly reduce a possibility of the high pressure fluid (e.g., combustion products) within the region 134 behind the detonation wave 130 from flowing in an upstream direction, i.e., into the incoming fuel/air mixture flow 132 (see FIG. 3).

Referring back to FIG. 2, and now also to FIG. 5, it will be appreciated that for the embodiment described herein, the nozzle 140 is configured as one of the plurality of nozzles 140 arranged in an array extending along the circumferential direction C of the RDC system 100. Referring particularly to FIG. 5, a view of the RDC system 100 at a forward end/upstream end is provided along the longitudinal centerline 116 of the RDC system 100.

More specifically, for the embodiment depicted, the plurality of nozzles 140 of the RDC system 100 includes multiple arrays of nozzles 140 spaced along the radial direction R of the RDC system 100. Particularly for the embodiment of FIG. 5, the plurality of nozzles 140 of the RDC system 100 includes a first array 166 of nozzles 140, a second array 168 of nozzles 140, and a third array 170 of nozzles 140, each array extending along the circumferential direction C of the RDC system 100, i.e., including a plurality of nozzles 140 arranged along the circumferential direction C of the RDC system 100. For the embodiment depicted, the third array 170 of nozzles 140 is located outward of the second array 168 of nozzles 140 along the radial direction R, and the second array 168 of nozzles 140 is located outward of the first array 166 of nozzles 140 along the radial direction R.

Although for the embodiment depicted, the RDC system 100 includes three arrays of nozzles 140 spaced along the radial direction R, in other exemplary embodiments the RDC system 100 may instead include any other suitable number of arrays of nozzles 140, such as one array, two arrays, four arrays, and, e.g., up to about twenty arrays. Further, although for the embodiment depicted each array includes the same number of nozzles 140, in other exemplary embodiments, the arrays may vary the number of nozzles 140. With one or more of the above configurations, the plurality of nozzles 140 of the RDC system 100 may include a relatively high number of nozzles 140. For example, in certain embodiments, the plurality of nozzles 140 may include at least fifty nozzles 140 and up to, e.g., 10,000 nozzles 140. For example, in certain embodiments, the plurality of nozzles 140 may include between about seventy-five nozzles 140 and about five hundred nozzles 140, such as between about one hundred nozzles 140 and about three hundred and fifty nozzles 140. Additionally, although the nozzles 140 of each array is arranged along the radial direction (i.e., each nozzle 140 has the same circumferential position as a corresponding nozzle 140 in a radially inward or outward array of nozzles 140), in other embodiments, the nozzles 140 of one array may be staggered relative to the nozzles 140 of a radially inward array and/or a radially outward array.

Moreover, in certain embodiments, each nozzle 140 in the plurality of nozzles 140 may be configured in accordance with one or more of the embodiments described above with reference to FIG. 4. Further, in certain embodiments, each nozzle 140 in the plurality of nozzles 140 may be configured in substantially the same manner, or alternatively, in other embodiments, one or more of the plurality of nozzles 140 may include a varied geometry. Furthermore, although each of the plurality of nozzles 140 is depicted as including a substantially circular nozzle inlet 144 (and a substantially circular nozzle flowpath 148 along the respective lengthwise directions 142), in other embodiments, one or more of the plurality of nozzles 140 instead define any other suitable cross-sectional shape along a respective lengthwise direction 142, such as an ovular shape, a polygonal shape, etc. Similarly, although the converging and diverging sections 159, 161 are depicted as conical, in other exemplary embodiments, one or both of the sections 159, 161 may be defined by curved walls, or any other suitable shape. Additionally, the throat 152 of the nozzle 140 may be a single point along the axial direction A, as opposed to an elongated cylindrical section.

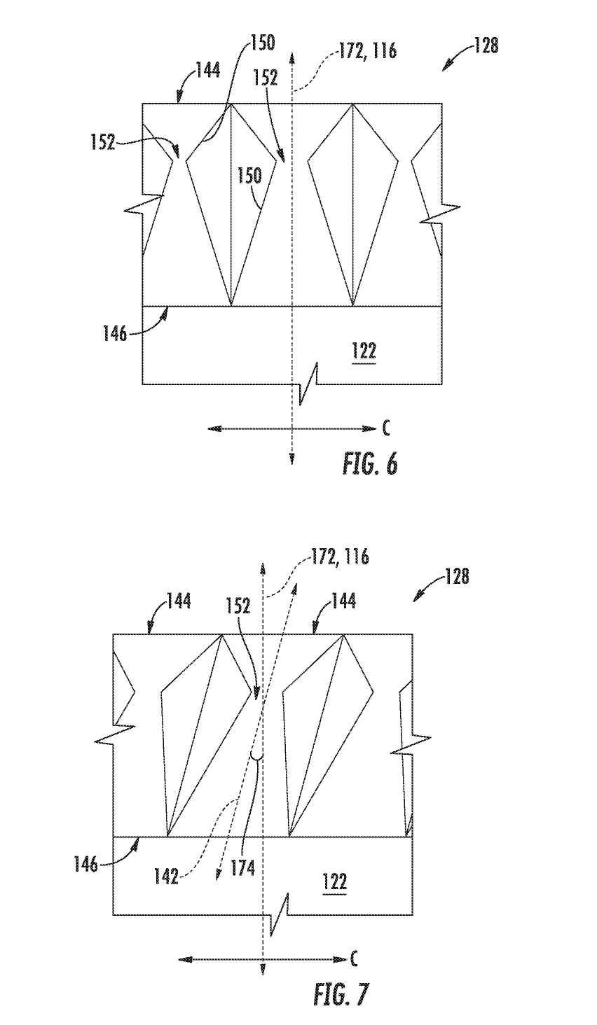

Further, referring now to FIG. 6, a radially outer, partially cross-sectional view of the RDC system 100 at a forward end of the RDC system 100 is provided. As discussed above, each nozzle 140 of the plurality of nozzles 140 extends between a respective nozzle inlet 144 and a nozzle outlet 146 along a lengthwise direction 142. Additionally, the RDC system 100 defines a longitudinal centerline 116. For the embodiment depicted, the lengthwise direction 142 of each nozzle 140 is substantially parallel to the longitudinal centerline 116 of the RDC system 100. More specifically, the longitudinal centerline 116 and radial direction R of the RDC system 100 defines a reference plane 172, and for the embodiment depicted, the lengthwise direction 142 of the nozzle 140 extends within or substantially parallel to the reference plane 172. The reference plane 172 may be the view depicted in, e.g., FIG. 2.

It should be appreciated, however, that in other exemplary embodiments, the nozzles 140 may instead define an angle relative to the longitudinal centerline 116. For example, referring now to FIG. 7, a radially outer, partially cross-sectional view of an RDC system 100 in accordance with another exemplary embodiment of the present disclosure is provided. The exemplary RDC system 100 of FIG. 7 may be configured in substantially the same manner as exemplary RDC system 100 of FIG. 6. For example, the RDC system 100 of FIG. 7 includes a plurality of nozzles 140, with each nozzle 140 extending between a respective nozzle inlet 144 and nozzle outlet 146 along a lengthwise direction 142. Additionally, the exemplary RDC system 100 of FIG. 7 defines a longitudinal centerline 116 and a radial direction R relative to the longitudinal centerline 116. The longitudinal centerline 116 and the radial direction R of the RDC system 100 together define a reference plane 172.

However, for the embodiment depicted, each of the plurality nozzles 140 are spiraled relative to the longitudinal centerline 116 of the RDC system 100. More specifically, the longitudinal direction of each nozzle 140 defines an angle 174 with the longitudinal centerline 116 of the RDC system 100. More particularly, with reference to the center nozzle 140 depicted, in which the lengthwise direction 142 of the nozzle 140 intersects the reference plane 172 (at a location within the nozzle flowpath 148 of the respective nozzle 140), the lengthwise direction 142 of the nozzle 140 defines an angle 174 greater than zero degrees and less than about forty-five degrees with the reference plane 172. For example, in certain exemplary embodiments, the angle 174 may be greater than five degrees and less than about forty degrees, such as greater than ten degrees and less than about thirty-five degrees.

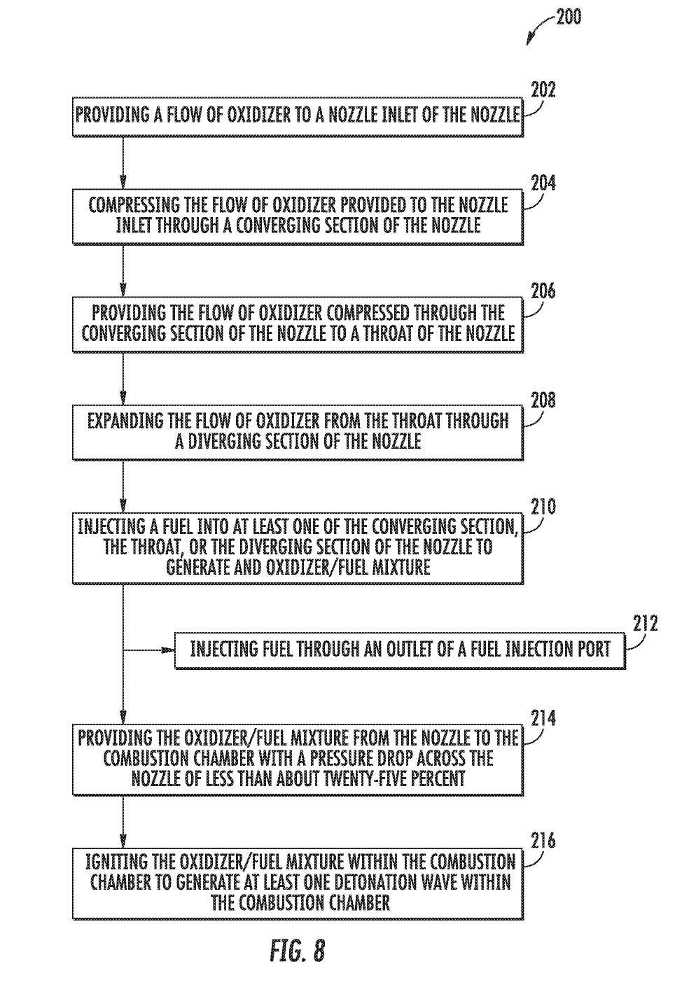

Additionally, referring now to FIG. 8 a method 200 of operating a rotating detonation combustion (“RDC”) system in accordance with an exemplary aspect of the present disclosure is provided. The exemplary method 200 may be used to operate one or more of the exemplary RDC systems described above with reference to FIGS. 1 through 7. Accordingly, the RDC system may generally define a combustion chamber and include a nozzle located at an inlet to the combustion chamber.

As is depicted, the method 200 generally includes at (202) providing a flow of oxidizer to a nozzle inlet of the nozzle. The oxidizer provided at (202) may be a flow of compressed air from, e.g., a compressor section of an engine including the RDC system, or a flow of oxidizer (such as oxygen, fluorine, etc.). The method 200 further includes at (204) compressing the flow of oxidizer provided to the nozzle inlet through a converging section of the nozzle, and at (206) providing the flow of oxidizer compressed through the converging section of the nozzle to a throat of the nozzle. Notably, the flow of oxidizer through the throat of the nozzle may define a speed less than Mach 1, and within about a twenty percent margin of Mach 1.

Referring still to FIG. 8, the method 200 further includes at (208) expanding the flow of oxidizer from the throat through a diverging section of the nozzle, and at (210) injecting a fuel into at least one of the converging section, the throat, or the diverging section of the nozzle to generate an oxidizer/fuel mixture. More specifically, for the exemplary aspect depicted, injecting fuel into at least one of the converging section, the throat, or the diverging section at (210) further includes at (212) injecting fuel through an outlet of a fuel injection port.

Further, still, for the exemplary aspect of FIG. 8, the method 200 includes at (214) providing the oxidizer/fuel mixture from the nozzle to the combustion chamber with a pressure drop across the nozzle of less than about twenty-five percent, such as less than about fifteen percent, such as less than about eight percent. Additionally, the exemplary aspect of FIG. 8 includes at (216) igniting the oxidizer/fuel mixture within the combustion chamber to generate at least one detonation wave within the combustion chamber.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A rotating detonation combustion system defining a radial direction and a circumferential direction, the rotating detonation combustion system comprising:
an outer wall and an inner wall together defining at least in part a combustion chamber and a combustion chamber inlet;
a nozzle located at the combustion chamber inlet defined by the outer wall and the inner wall, the nozzle defining a lengthwise direction and extending between a nozzle inlet and a nozzle outlet along the lengthwise direction, the nozzle inlet configured to receive a flow of oxidizer, the nozzle further defining a throat between the nozzle inlet and nozzle outlet; and
a fuel injection port defining a fuel outlet located between the nozzle inlet and the nozzle outlet for providing fuel to the flow of oxidizer received through the nozzle inlet.

2. The rotating detonation combustion system of claim 1, wherein the nozzle is configured as one of a plurality of nozzles arranged in an array along the circumferential direction.

3. The rotating detonation combustion system of claim 2, wherein the plurality of nozzles includes a first array of nozzles and a second array of nozzles, wherein the second array of nozzles is located outward of the first array of nozzles along the radial direction.

4. The rotating detonation combustion system of claim 3, wherein the plurality of nozzles further includes a third array of nozzles, wherein the third array of nozzles is located outward of the second array of nozzles along the radial direction.

5. The rotating detonation combustion system of claim 2, wherein the plurality of nozzles includes at least fifty nozzles spaced along the circumferential direction.

6. The rotating detonation combustion system of claim 1, wherein the nozzle inlet defines a nozzle inlet cross-sectional area, wherein the throat defines a throat cross-sectional area, wherein the throat cross-sectional area is less than or equal to about one half of the nozzle inlet cross-sectional area.

7. The rotating detonation combustion system of claim 6, wherein the nozzle outlet defines a nozzle outlet cross-sectional area, wherein the nozzle outlet cross-sectional area is less than or equal to the nozzle inlet cross-sectional area.

8. The rotating detonation combustion system of claim 1, wherein nozzle defines a length along the lengthwise direction, and wherein the throat is positioned in a forward half of the length of the nozzle.

9. The rotating detonation combustion system of claim 1, wherein the fuel outlet of the fuel injection port is positioned at the throat of the nozzle or positioned downstream of the throat of the nozzle along the lengthwise direction of the nozzle.

10. The rotating detonation combustion system of claim 1, wherein the nozzle defines a nozzle length, wherein the fuel outlet of the fuel injection port is positioned at the throat of the nozzle or within a buffer distance from the throat of the nozzle along the lengthwise direction, wherein the buffer distance is ten percent of the nozzle length.

11. The rotating detonation combustion system of claim 1, wherein the fuel injection port is integrated into the nozzle.

12. The rotating detonation combustion system of claim 1, wherein the rotating detonation combustion system further defines a longitudinal centerline, and wherein the lengthwise direction of the nozzle is substantially parallel to the longitudinal centerline.

13. The rotating detonation combustion system of claim 1, wherein the rotating detonation combustion system further defines a longitudinal centerline, wherein the longitudinal centerline and the radial direction together define a reference plane, wherein the lengthwise direction of the nozzle intersects the reference plane and defines an angle greater than zero degrees and less than forty-five degrees with the reference plane.

14. The rotating detonation combustion system of claim 1, wherein the fuel injection port comprises a plurality of fuel injection ports.

15. A turbine engine comprising:
a turbine section; and
a rotating detonation combustion system located upstream of the turbine section, the rotating detonation combustion system comprising:
an outer wall and an inner wall together defining in part a combustion chamber, a combustion chamber inlet, and a combustion chamber outlet, the combustion chamber outlet in flow communication with the turbine section;
a nozzle located at the combustion chamber inlet defined by the outer wall and the inner wall, the nozzle defining a lengthwise direction and extending between a nozzle inlet and a nozzle outlet along the lengthwise direction, the nozzle inlet configured to receive a flow of oxidizer, the nozzle further defining a throat between the nozzle inlet and nozzle outlet; and
a fuel injection port defining a fuel outlet located between the nozzle inlet and the nozzle outlet for providing fuel to the flow of oxidizer received through the nozzle inlet.

16. A method of operating a rotating detonation combustion system, the rotating detonation combustion system defining a combustion chamber and comprising a nozzle located at an inlet to the combustion chamber, the method comprising:
providing a flow of oxidizer to a nozzle inlet of the nozzle;
compressing the flow of oxidizer provided to the nozzle inlet through a converging section of the nozzle;
providing the flow of oxidizer compressed through the converging section of the nozzle to a throat of the nozzle;
expanding the flow of oxidizer from the throat through a diverging section of the nozzle;
injecting a fuel into at least one of the converging section, the throat, or the diverging section to generate an oxidizer/fuel mixture; and
igniting the oxidizer/fuel mixture within the combustion chamber to generate at least one detonation wave within the combustion chamber.

17. The method of claim 16, wherein the flow of oxidizer through the throat of the nozzle defines a speed within about a twenty percent margin of Mach 1.

18. The method of claim 16, wherein injecting a fuel into at least one of the converging section, the throat, or the diverging section comprises injecting fuel through an outlet of a fuel injection port.

19. The method of claim 16, further comprising:
providing the oxidizer/fuel mixture from the nozzle to the combustion chamber with a pressure drop across the nozzle of less than about twenty-five percent.

20. The method of claim 16, further comprising:
providing the oxidizer/fuel mixture from the nozzle to the combustion chamber with a pressure drop across the nozzle of less than about fifteen percent.
